(19) United States
(12) Patent Application Publication
(10) Pub. No.: US 2023/0331978 A1
(43) Pub. Date: Oct. 19, 2023

(54) POLYACETAL RESIN COMPOSITION

(71) Applicant: Polyplastics Co., Ltd., Tokyo (JP)

(72) Inventors: Yuhei HOSOI, Fuji-shi (JP); Akihiro TAMAOKA, Fuji-shi (JP); Hiroki ARAI, Fuji-shi (JP); Tomohiro MONMA, Fuji-shi (JP)

(21) Appl. No.: 18/338,790

(22) Filed: Jun. 21, 2023

Related U.S. Application Data
(63) Continuation of application No. PCT/JP2021/033857, filed on Sep. 15, 2021.

(30) Foreign Application Priority Data
Dec. 24, 2020 (JP) 2020-214497

(51) Int. Cl. C08L 59/04; C08L 71/02; C08K 3/22; C08K 5/3472; C08K 5/20; C08K 5/13; C08K 5/17

(52) U.S. Cl. CPC C08L 59/04; C08K 3/22; C08K 5/13; C08K 5/17; C08K 5/20; C08K 5/3472; C08L 71/02; C08K 2003/222; C08K 2003/2296; C08K 2201/006; C08K 2201/014

(57) ABSTRACT

A polyacetal resin composition that allows molded articles to be inhibited from being deteriorated by contact with acidic detergents, and in which the portions that have contacted the detergents are inhibited from being deteriorated by light. The polyacetal resin composition includes 100 parts by mass of a polyacetal polymer, 0.1-2.0 parts by mass of a hindered-phenol-based antioxidant, 2.0-20 parts, excluding 2.0 parts, by mass of at least one of magnesium oxide and zinc oxide,0.5-3.0 parts by mass of a polyalkylene glycol, 0.2-1.5 parts by mass of a hindered amine compound, and 0.2-1.5 parts by mass of an ultraviolet absorber.

### RELATED APPLICATIONS

This application is a continuation of Internatioanl Application No. PCT/JP2021/033857, filed Sep. 15, 2021, which claims priority to Japanese Patent Application No. 2020-214497, filed Dec. 24, 2020, the entire content of which is incorporated by refefrence.

### TECHNICAL FIELD

The present invention relates to a polyacetal resin composition having high resistance against acidic components.

### BACKGROUND ART

Since polyacetal resins are excellent in chemical resistance, molded articles formed of a polyacetal resin as a raw material have been widely used as automotive components. For example, they have been used for large components such as fuel delivery units, representative examples of which are fuel contact bodies, such as fuel pump modules, which directly contact fuel oil.

In recent years, sulfur reduction of fuels has progressed in order to respond to environmental regulations in various countries. However, since desulfurization equipment is highly costly, high sulfur-containing fuels are still being distributed in some countries. These high sulfur fuels tend to deteriorate the polyacetal resin more easily than low sulfur fuels.

Moreover, although automobile components such as fuel delivery units are covered with a casing such as a hood, splashes of cleaner may sometimes adhere during car washing. In particular, when removing brake dust or the like attached to a wheel, strongly acidic cleaners, which are more acidic than high sulfur-containing fuels, may be used. Such cleaners are capable of degrading automobile components formed of polyacetal resins and this is also a serious problem.

The Applicant of the present application reported that these problems can be significantly improved by formulating a hindered phenol-based antioxidant, an oxide of alkali earth metal, and a polyalkylene glycol to a polyacetal resin (Patent Document 1).

Patent Document 1: Japanese Patent No.6386124

### SUMMARY OF THE INVENTION

### Problems to Be Solved by the Invention

Although automobile components such as a fuel delivery unit, etc. are often covered with a casing such as a hood, they are sometimes exposed to sunlight during assembly or use. Also, depending upon car types, a fuel tank is not covered with a casing, and some of the fuel delivery tanks are used while they are exposed to sunlight. Moreover, to these components, splashes of cleaner may sometimes adhere during car washing. In particular, strongly acidic cleaners which are more acidic than high sulfur-containing fuels may be used for wheels, which causes automobile components which are formed of polyacetal resin and which have undergone photodegradation due to sunlight to rapidly degrade, and this is also a serious problem.

An object of the present invention is to provide a polyacetal resin composition which can prevent a portion of a molded product formed of the acetal resin composition from being degraded, when the portion is irradiated with sunlight and is then in contact with an acidic cleaner.

### Means for Solving the Problems

The present inventors have made diligent research to solve the above-mentioned problem, and have found that if the composition of the polyacetal resin composition is set to a specific one, degradation of a portion of a molded product formed of the acetal resin composition can be minimized, when the portion is irradiated with sunlight and is then in contact with an acidic cleaner.

Namely, the present invention relates to the following. In a first aspect of the present invention, provided is a polyacetal resin composition, including:
(A) a polyacetal polymer in an amount of 100 parts by mass,
(B) a hindered phenol-based antioxidant in an amount of 0.1 parts by mass or more and 2.0 parts by mass or less,
(C) at least one type selected from oxides of magnesium or zinc in an amount of more than 2.0 parts by mass and 20 parts by mass or less,
(D) a polyalkylene glycol in an amount of 0.5 parts by mass or more and 3.0 parts by mass or less,
(E) a hindered amine compound in an amount of 0.2 parts by mass or more and 1.5 parts by mass or less, and
(F) an ultraviolet absorber in an amount of 0.2 parts by mass or more and 1.5 parts by mass or less.

In a second aspect of the present invention, provided is the polyacetal resin composition as described in the first aspect, in which the at least one type selected from oxides of magnesium or zinc is magnesium oxide.

In a third aspect of the present invention, provided is the polyacetal resin composition as described in the first or second aspect, in which the magnesium oxide has a BET specific surface area of 100 m²/g or more.

In a fourth aspect of the present invention, provided is the polyacetal resin composition as described in any one of the first to third aspects, in which (F) the ultraviolet absorber is at least one type selected from benzotriazole-based compounds or oxamide-based compounds. In a fifth aspect of the present invention, provided is the polyacetal resin composition as described in any one of the first to fourth aspects, in which (F) the ultraviolet absorber is at least one type selected from 2-(2H-benzotriazol-2-yl)-4,6-bis (1-methyl-1-phenylethyl)phenol or N-(2-ethylphenyl)-N′-(2-ethoxyphenyl)oxamide.

In a sixth aspect of the present invention, provided is an automobile component including a molded product of the polyacetal resin composition as described in any one of the first to fifth aspects.

In a seventh aspect of the present invention, provided is the automobile component as described in the sixth aspect, in which the automobile component is an automobile component brought into contact with an acidic cleaner.

In an eighth aspect of the present invention, provided is a method for improving acid resistance against an acidic component, by using the acetal resin composition as described in any one of the first to fifth aspects.

In a ninth aspect of the present invention, provided is the method as described in the eighth aspect, in which the acidic component is derived from an acidic cleaner.

### Effects of the Invention

According to the present invention, it is possible to provide a polyacetal resin composition which can minimize degradation of a portion of a molded product produced of the polyacetal resin composition, the portion being in contact with an acidic cleaner after irradiation with sunlight. It should be noted that in the present invention, the term “acidic cleaner” refers to a cleaner having a pH of 6 or less, optionally 2 or less, and examples thereof include a wheel cleaner.

### DETAILED DESCRIPTION OF THE PREFERRED EMBODIMENTS

Below, specific embodiments of the present invention are explained in detail, but the present invention is not in any way limited to the below embodiments, and within the scope of the object of the present invention, suitable modifications may be implemented.

### Polyacetal Resin Composition

The polyacetal resin composition of the embodiment of the present invention is characterized by including: with respect to (A) a polyacetal polymer in an amount of 100 parts by mass, (B) a hindered phenol-based antioxidant in an amount of 0.1 parts by mass or more and 2.0 parts by mass or less, (C) at least one type selected from oxides of magnesium or zinc in an amount of more than 2.0 parts by mass and 20 parts by mass or less, (D) 0.5 parts by mass or more and 3.0 parts by mass or less of a polyalkylene glycol, (E) a hindered amine compound in an amount of 0.2 parts by mass or more and 1.5 parts by mass or less, and (F) an ultraviolet absorber in an amount of 0.2 parts by mass or more and 1.5 parts by mass or less.

### (A) Polyacetal Polymer

A polyacetal polymer (A) used in the embodiment of the present invention may be a homopolymer of an oxymethylene group (—OCH₂—) as a constituent unit or a copolymer having another copolymer unit other than the oxymethylene unit and may be preferably a copolymer.

Generally, the polyacetal copolymer is produced by copolymerizing formaldehyde or a cyclic compound of formaldehyde as a main monomer and a compound selected from cyclic ethers or cyclic formals as a comonomer. Generally, unstable parts at the terminal are removed by thermal decomposition or (alkali) hydrolysis to promote stability.

In particular, as the main monomer, trioxane, a cyclic trimer of formaldehyde, is commonly used. Trioxane is generally obtained by reacting an aqueous formaldehyde solution in the presence of an acidic catalyst. This is purified by a method such as distillation and is used. Preferable trioxane used for polymerization contains impurities, such as water, methanol, formic acid and the like, as little as possible.

As the comonomer, common cyclic ethers, cyclic formals, and glycidyl ether compounds that can form branched structures or crosslinking structures can be used alone or in a combination of two or more.

The polyacetal polymers as described above generally can be obtained by adding an appropriate amount of a molecular weight regulator and performing cationic polymerization using a cationic polymerization catalyst. Molecular weight regulators, cationic polymerization catalysts, polymerization methods, polymerization apparatuses, deactivation treatments of catalysts after polymerization, and terminal stabilization treatment methods of crude polyacetal polymers obtained by polymerization, and the like, which are used, are known from many documents, and basically any of them can be available.

Particularly preferred production methods of the polyacetal polymer include the following method. That is, a method in which copolymerization is performed by using trioxane as a main monomer (a), at least one type selected from cyclic ethers or cyclic formals having at least one carbon-carbon bond as a comonomer (b), a heteropoly acid as the polymerization catalyst (c), and then, a carbonate, a hydrogen carbonate, a carboxylate or hydrate thereof (d) of an alkali metal element or alkaline earth metal element is added and melt-kneaded to deactivate the polymerization catalyst (c). By using the polyacetal polymer according to the present method, an amount of formaldehyde generated from the molded article can be further reduced and occurrence of mold deposits during molding can be suppressed.

The term “heteropoly acid” used as the polymerization catalyst (c) is a generic term for poly acids produced by dehydration condensation of different types of oxygen acids, and the heteropoly acid has a mononuclear or multinuclear complex ion formed of a specific hetero element existing at the center and condensation acid groups with an oxygen atom being shared.

Examples of the heteropoly acid include: phosphomolybdic acid, phosphotungstic acid, phosphomolybdotungstic acid, phosphomolybdovanadic acid, phosphomolybdotungstovanadic acid, phosphotungstovanadic acid, silicotungstic acid, silicomolybdic acid, silicomolybdotungstic acid, silicomolybdotungstentvanadic acid, etc. Among them, in consideration of stability of polymerization and stability of the heteropoly acid itself, it is preferable that the heteropoly acid is at least one of silicomolybdic acid, silicotungstic acid, phosphomolybdic acid or phosphotungstic acid.

The used amount of the heteropoly acid varies depending on the type of the heteropoly acid, and the polymerization reaction can be adjusted by appropriately changing the used amount. Generally, the used amount is in the range of 0.05 to 100 ppm (hereinafter, ppm refers to ppm/ppm by mass), preferably 0.1 to 50 ppm, based on the total amount of monomers to be polymerized.

As the polymerization apparatus, a reactor equipped with a stirrer which is generally used in a batch system can be used. As a continuous system, a continuous mixer such as a Co-Kneader, a twin-screw continuous extrusion mixer, and a twin-screw paddle type continuous mixer can be used. Other than the above, continuous polymerization apparatuses for trioxane, etc. proposed so far can be used. Furthermore, a combination of two or more types of polymerization apparatuses can be used.

The polymerization method is not particularly limited, but as previously proposed, if trioxane, a comonomer, and a heteropoly acid as the polymerization catalyst are sufficiently mixed in advance, and the resulting mixture of reaction raw materials is supplied to a polymerization apparatus while maintaining the liquid phase state, to carry out the copolymerization reaction, a catalyst amount required can be reduced. As a result, this is advantageous in obtaining a polyacetal copolymer with a less amount of released formaldehyde, and is a more preferable polymerization method. The polymerization temperature is in the range of 60 to 120° C.

In the embodiment of the present invention, when preparing a polyacetal copolymer by polymerizing the main monomer (a) and the comonomer (b), it is also possible to add a known chain transfer agent for adjusting a degree of polymerization, such as a linear acetal having a low molecular weight, e.g., methylal.

Further, the polymerization reaction is preferably carried out in a state in which impurities having active hydrogen, for example, water, methanol, formic acid, and the like, are substantially absent, for example, in a state in which these impurities each are present in 10 ppm or less. For this purpose, it is preferable to use, as the main monomer or comonomer, trioxane, cyclic ethers, and/or cyclic formals which have been prepared so as to contain as little as possible of these impurity components.

A carbonate, a hydrogen carbonate, a carboxylate or hydrate thereof (d) of an alkali metal element or an alkaline earth metal element is melt-kneaded with the thus-obtained polyacetal polymer (crude polyacetal polymer) containing the polymerization catalyst and having unstable parts at terminals thereof, thereby to deactivate the polymerization catalyst and reduce an amount of unstable terminal groups of the polyacetal polymer (crude polyacetal polymer) to stabilize the polyacetal polymer.

The molecular weight of the polyacetal polymer (A) used in the embodiment of the present invention is not particularly limited, but the weight average molecular weight equivalent to PMMA (polymethyl methacrylate) determined by size exclusion chromatography is preferably about 10,000 to 400,000. It is preferable that a melt index (measured at 190° C. under a load of 2.16 kg according to ASTM-D1238) serving as an index of fluidity of the resin is 0.1 to 100 g/10 min, and more preferably 0.5 to 80 g/10 min.

It is particularly preferred that the polyacetal polymer (A) used in the embodiment of the present invention has specific terminal characteristics. Specifically, the polyacetal polymer (A) has an amount of hemiformal terminal group of 1.0 mmol/kg or less, an amount of a formyl terminal group of 0.5 mmol/kg or less, and an amount of unstable terminal of 0.5% by mass or less. Here, the hemiformal terminal group is represented by —OCH₂OH, and is also referred to as a hydroxymethoxy group or a hemiacetal terminal group. The formyl terminal group is represented by —OCH₂OCHO. Amounts of such a hemiformal terminal group and a formyl terminal group can be determined by ¹H-NMR measurement and for a specific measurement method thereof, a method described in Japanese Unexamined Patent Application, Publication No. 2001-11143 can be referred to.

Herein, the amount of the unstable terminal refers to an amount of parts which are present at terminal parts of the polyacetal polymer and which easily decompose due to instability against heat or a base. The amount of such unstable terminal is determined as follows: 1 g of a polyacetal polymer is placed in a pressure-resistant closed vessel together with 100 mL of a 50% (by volume) aqueous methanol solution containing 0.5% (by volume) of ammonium hydroxide, subjected to a heat treatment at 180° C. for 45 minutes, and then cooled; the vessel is opened, and an amount of formaldehyde which has resulted from degradation and has been eluted into the resultant solution is quantified and is represented as % by mass relative to the polyacetal polymer.

The polyacetal polymer (A) used in the embodiment of the present invention preferably has an amount of the hemiformal terminal group of 1.0 mmol/kg or less and more preferably 0.6 mmol/kg or less. An amount of the formyl end group is preferably 0.5 mmol/kg or less and more preferably 0.1 mmol/kg or less. An amount of the unstable terminal is preferably 0.5% by mass or less and more preferably 0.3% by mass or less. Lower limits of the amount of the hemiformal terminal group, the amount of the formyl terminal group, and the amount of the unstable terminal are not particularly limited.

As mentioned above, the polyacetal polymer (A) having a specific terminal property can be produced by reducing impurities contained in the monomer and the comonomer, optimizing selection of production processes and production conditions thereof.

As a method for producing the polyacetal polymer (A) having a specific terminal property that meets the following requirements of the embodiment of the present invention, for example, a method described in Japanese Unexamined Patent Application, Publication No. 2009-286874 may be used. However, the method is not limited thereto.

In the embodiment of the present invention, a polyacetal polymer having a branched-or crosslinked-structure may be added to the polyacetal polymer (A) and used. In this case, the added amount is 0.01 to 20 parts by mass and particularly preferably 0.03 to 5 parts by mass with respect to 100 parts by mass of the polyacetal polymer (A).

### (B) Hindered Phenol-Based Antioxidants

Examples of the hindered phenol-based antioxidant (B) used in the embodiment of the present invention include: 2,2′-methylenebis(4-methyl-6-t-butylphenol), 1,6-hexanediol bis[3-(3,5-di-t-butyl-4-hydroxyphenyl)propionate], pentaerythritol tetrakis[3-(3,5-di-t-butyl-4-hydroxyphenyl)propionate], bis[3-(3-t-butyl-4-hydroxy-5-methylphenyl)propionic acid] (ethylene bis(oxy)bisethylene), 1,3,5-trimethyl-2,4,6-tris(3,5-di-t-butyl-4-hydroxybenzyl)benzene, n-octadecyl-3-(3,5-di-t-butyl-4-hydroxyphenyl)propionate, 4,4′-methylenebis(2,6-di-t-butylphenol), 4,4′-butyridene-bis(6-t-butyl-3-methyl-phenol), distearyl-3,5-di-t-butyl-4-hydroxybenzyl phosphonate, 2-t-butyl-6-(3-t-butyl-5-methyl-2-hydroxybenzyl)-4-methylphenyl acrylate, 3,9-bis{2-[3-(3-t-butyl-4-hydroxy-5-methylphenyl)propionyloxy]-1,1-dimethylethyl}-2,4,8,10-tetraoxaspiro[5,5]undecane, and the like.

In the embodiment of the present invention, at least one type or two or more types selected from these antioxidants can be used.

A content of the hindered phenol-based antioxidant (B) in the embodiment of the present invention is 0.1 to 1.0 part by mass, and more preferably 0.2 to 0.5 parts by mass, with respect to 100 parts by mass of the polyacetal resin (A). When the blended amount of the antioxidant (B) is small, not only is the antioxidant property, which is the original purpose, insufficient, but also cleaner resistance, which is the purpose of the embodiment of the present invention, is poor. When the blended amount of the antioxidant (B) is excessive, undesired influences occur in mechanical properties and moldability of the resin composition.

### (C) At Least One Type Selected From Oxides of Magnesium or Zinc

Examples of at least one type (hereinafter abbreviated as compound (C)) selected from oxides of magnesium or zinc (C) used in the embodiment of the present invention include magnesium oxide and zinc oxide. Among these compounds, magnesium oxide is preferable because it is excellent in improvement in cleaner resistance and balance of performance such as mechanical properties and moldability. With respect to magnesium oxide, magnesium oxide having a BET specific surface area of 100 m²/g or more is more preferable.

The content of the compound (C) in the embodiment of the present invention is preferably more than 2.0 parts by mass and 30 parts by mass or less, and more preferably more than 2.0 parts by mass and 10 parts by mass or less, with respect to 100 parts by mass of the polyacetal resin (A).

When the amount exceeds 2.0 parts by mass, the acidic cleaner resistance is particularly excellent, and when the amount is within 30 parts by mass, stable production is possible. Within 10 parts by mass, the balance of mechanical properties is particularly excellent. So far, as the amount of the compound (C) increased, decomposition of the unstable terminals in the polyacetal resin sometimes developed. However, since the polyacetal copolymer (A) of the embodiment of the present invention can suppress such decomposition, it is possible to find a characteristic of improvement in acid resistance by increasing the amount of the compound (C).

### (D)Polyalkylene Glycol

In the embodiment of the present invention, it is also preferable that a polyalkylene glycol (D) is contained. Although the type of polyalkylene glycol is not particularly limited, from the viewpoint of compatibility with the polyacetal resin, that containing polyethylene glycol or polypropylene glycol is preferable, and polyethylene glycol is more preferable.

The number average molecular weight (Mn) of the polyalkylene glycol is not particularly limited, but from the viewpoint of dispersibility in the polyacetal resin, it is preferably 1,000 or more and 50,000 or less, and more preferably 5,000 or more and 30,000 or less. In this specification, the number average molecular weight is polystyrene equivalent molecular weight obtained by size exclusion chromatography using tetrahydrofuran (THF) as a solvent.

The content of the polyalkylene glycol (D) in the embodiment of the present invention is 0.5 to 3.0 parts by mass, and more preferably 1.0 to 2.0 parts by mass, with respect to 100 parts by mass of polyacetal resin (A). The upper limit of the addition amount is selected in consideration with regard to balance with the mechanical properties of the molded product. These may be used by mixing two or more.

### (E) Hindered Amine Compounds

The hindered amine compound (hereinafter also referred to as HALS) used in the embodiment of the present invention is not particularly limited, but a hindered amine compound in which a nitrogen atom of a piperidine derivative having a steric hindrance group such as a methyl group at adjacent carbon atoms is secondary or tertiary is preferably used.

Examples of the hindered amine stabilizer used in the embodiment of the present invention in which the nitrogen atom of the piperidine derivative having steric hindrance groups is secondary include: bis(2,2,6,6-tetramethyl-4-piperidyl) sebacate, a condensate of 1,2,3,4-butane tetracarboxylic acid, 2,2,6,6-tetramethyl-4-piperidinol, and β,β,β′,β′-tetramethyl-3,9-(2,4,8,10-tetraoxaspi ro[ 5.5 ]undecane)-diethanol, tetrakis(2,2,6,6-tetramethyl-4-piperidyl) 1,2,3,4-butanetetracarboxylate, a condensate of 1,2,3,4 butane tetracarboxylic acid, 2,2,6,6-tetramethyl-4-piperidinol, and tridecyl alcohol, and the like.

Examples of the hindered amine compound used in the embodiment of the present invention, in which the nitrogen atom of the piperidine derivative having steric hindrance groups is tertiary include: bis- or tris-piperidyl esters of aliphatic di- or tri-carboxylic acid (bispiperidyl esters of aliphatic dicarboxylic acids having 2 to 20 carbon atoms), such as bis(1,2,2,6,6-pentamethyl-4-piperidyl) adipate and bis(1-octyloxy-2,2,6,6-tetramethyl-4-piperidyl sebacate, N,N′,N″,N‴-tetrakis-(4,6-bis-(butyl-(N-methyl-2,2,6,6-tetramethylpiperidin-4-yl)amino)-triazin-2-yl)-4,7-diazadecane-1,10-diamine, polymer of dimethyl succinate and 4-hydroxy-2,2,6,6-tetramethyl-1-piperidineethanol, decanedioic acid bis(2,2,6,6-tetramethyl-1-(octyloxy)-4-piperidinyl) ester, bis(1,2,2,6,6-pentamethyl-4-piperidyl)[[3,5-bis(1,1-dimethylethyl)-4-hydroxyphenyl]methyl]butyl malonate, bis(1,2,2,6,6-pentamethyl-4-piperidyl) sebacate, methyl-1,2,2,6,6-pentamethyl-4-piperidyl sebacate, tetrakis(1,2,2,6,6-pentamethyl-4-piperidinyl) 1,2,3,4-butane tetracarboxylate, a condensate of 1,2,3,4-butane tetracarboxylic acid, 1,2,2,6,6-pentamethyl-4-piperidinol, and tridecyl alcohol, a condensate of 1,2,3,4-butane tetracarboxylic acid, 1,2,2,6,6-pentamethyl-4-piperidinol, β,β,β′,β′-tetramethyl-3,9-(2,4,8,10-tetraoxaspiro[5.5]undecane)-diethanol, a reaction product of peroxidized 4-butylamino-2,2,6,6-tetramethylpiperidine, 2,4,6-trichloro-1,3,5-triazine, cyclohexane, and N,N′-ethane-1,2-diylbis(1,3-propanediamine), and 1-[2-{3-(3,5-di-t-butyl-4-hydroxyphenyl)propionyloxy}ethyl]-4-{3-(3,5-di-t-butyl-4-hydroxyphenyl)propionyloxy}-2,2,6,6-tetramethylpiperidine.

Particularly preferred are the following: bis(2,2,6,6-tetramethyl-4-piperidyl) sebacate, tetrakis(1,2,2,6,6-pentamethyl-4-piperidinyl) 1,2,3,4-butane tetracarboxylate, a condensate of 1,2,3,4-butane tetracarboxylic acid, 1,2,2,6,6-pentamethyl-4-piperidinol and β,β,β′,β′-tetramethyl-3,9-(2,4,8,10-tetraoxaspiro[5.5]undecane)-diethanol, and polymer of dimethyl succinate and 4-hydroxy-2,2,6,6-tetramethyl-1-piperidineethanol.

In the embodiment of the present invention, an addition amount of the hindered amine compound (E) is 0.2 to 1.5 parts by mass, and preferably 0.4 to 0.8 parts by mass, with respect to 100 parts by mass of the polyacetal polymer (A).

When the amount of the hindered amine compound (E) is too small, a polyacetal resin composition excellent in weathering resistance cannot be obtained, and when the amount of the hindered amine compound is too large, problems such as deterioration of mechanical properties and poor appearance due to bleeding occur.

### (F) Ultraviolet Absorber

Examples of the ultraviolet absorber of the embodiment of the present invention include benzotriazole-based compounds and oxanilide-based compounds, and these light stabilizers can be used alone or in combination of two or more types thereof.

Examples of benzotriazole-based compounds include: benzotriazoles having a hydroxy group and alkyl group (with 1 to 6 carbon atoms)-substituted aryl group, such as 2-(2H-benzotriazol-2-yl)-p-cresol, 2-(2H-benzotriazol-2-yl)-4,6-bis(1-methyl-1-phenylethyl)phenol, 2-[5-chloro(2H)-benzotriazol-2-yl)-4-methyl-6-(t-butyl)phenol, 2,4-di-t-butyl-6-(5-chlorobenzotriazol-2-yl)phenol, 2-(2H-benzotriazol-2-yl)-4,6-di-t-pentylphenol, 2-(2H-benzotriazol-2-yl)-4-(1,1,3,3-tetramethylbutyl)phenol, and 2-[2′-hydroxy-3′,5′-di-isoamylphenyl)benzotriazole, benzotriazoles having a hydroxy group and aralkyl (or an aryl) group-substituted aryl group such as 2-[2′-hydroxy-3’,5′-bis(α,α-dimethylbenzyl)phenyl]benzotriazole, benzotriazoles having a hydroxy group and alkoxy group (C1 to C12 alkoxy)-substituted aryl group, such as 2-(2′-hydroxy-4′-octoxyphenyl)benzotriazole, and the like.

These benzotriazole compounds can be used alone or in combination of two or more types thereof.

Among these benzotriazole-based compounds, 2-(2H-benzotriazol-2-yl)-4,6-bis(1-methyl-1-phenylethyl)phenol, 2-(2H-benzotriazol-2-yl)-4,6-di-t-pentylphenol, 2-(2H-benzotriazol-2-yl)-4-(1,1,3,3-tetramethylbutyl)phenol and the like are preferred.

Examples of oxanilide-based compounds include: N-(2-ethylphenyl)-N′-(2-ethoxy-5-t-butylphenyl)oxamide, N-(2-ethylphenyl)-N′-(2-ethoxyphenyl)oxamide, oxamides having an aryl group optionally substituted on the nitrogen atom, and the like. The oxanilide compounds may be used alone or in combination of two or more types thereof.

In the embodiment of the present invention, an addition amount of the ultraviolet absorber (F) is 0.2 to 1.5 parts by mass with respect to 100 parts by mass of the polyacetal polymer (A). The amount is preferably 0.4 to 0.8 parts by mass. When the blending amount of the ultraviolet absorber (F) is too small, a polyacetal resin composition excellent in weathering resistance cannot be obtained and when the amount of the ultraviolet absorber (F) is too large, problems such as deterioration of mechanical properties and poor appearance due to bleeding occur.

### Other Components

The polyacetal resin composition of the embodiment of the present invention may contain other components as necessary. As long as the object and effect of the embodiment of the present invention are not inhibited, one or more known stabilizers for the polyacetal resin composition may be added.

### Automobile Components Including Molded Articles of Polyacetal Resin Compositions

Molded articles formed of the polyacetal resin composition of the embodiment of the present invention can be used for all automobile components which may be brought into contact with a cleaner during car washing, such as an automobile wheel.

Molded articles thereof can be obtained by molding the above polyacetal resin composition by a conventional molding method such as injection molding, extrusion molding, compression molding, blow molding, vacuum molding, foam molding, or rotary molding.

Even if the molded article of the embodiment of the present invention comes into contact with, for example, a strongly acidic cleaner having a pH of 2 or less, degradation of the contact portion due to acid and photodegradation are suppressed, and a good surface appearance of the molded article can be maintained.

### EXAMPLES

Hereinafter, the present invention will be specifically described with reference to the Examples, but the present invention is not limited thereto.

Components in Tables 1 and 2 are as follows. The units in the Tables are parts by mass.

### (A) Polyacetal Polymer

### (A Polyacetal Polymer [Hemiformal Terminal Group Amount = 1.0 Mmol/kg, Melt Index (Measured at 190° C. Under a Load of 2.16 kg According to ASTM-D1238) = 9 g/10 min]

The polyacetal polymer A-1 was prepared as follows.

A-1: A mixture of 96.7% by mass of trioxane and 3.3% by mass of 1,3-dioxolane was continuously supplied to a twin-screw paddle type continuous polymerization machine, and 15 ppm of boron trifluoride was added as a catalyst to carry out polymerization. The mixture of trioxane and 1,3-dioxolane used for polymerization contained 10 ppm of water, 3.5 ppm of methanol, and 5 ppm of formic acid as impurities.

To the polymer discharged from the discharge port of the polymerization machine, an aqueous solution containing 1000 ppm of triethylamine was added, the obtained mixture was immediately pulverized and stirred to deactivate the catalyst, and then was centrifuged and dried to obtain a crude polyacetal copolymer.

Next, this crude polyoxymethylene copolymer was supplied to a twin-screw extruder having a vent port, and was subjected to melt kneading at a resin temperature of about 220° C., so that unstable terminals were degraded, and a volatile component containing a degradation product was vaporized off under reduced pressure from the vent port. The polymer withdrawn from the die of the extruder was cooled and shredded to obtain polyacetal copolymer A-1 in the form of pellets, in which the unstable terminals were removed.

### (B) Hindered Phenol-Based Antioxidant

(B-1) Pentaerythritol tetrakis[3-(3,5-di-t-butyl-4-hydroxyphenyl)propionate] (product name: Irganox1010: manufactured by BASF)
(B-2) Bis[3-(3-t-butyl-4-hydroxy-5-methylphenyl)propionic acid] (ethylenebisoxy)bisethylene) (product name: Irganox 245: manufactured by BASF)

### (C) Metal Compound

(C-1) Magnesium oxide, BET specific surface area of 135 m²/g, average particle size of 0.9 µm (product name: Kyowamag MF150, manufactured by Kyowa Chemical Industry Co., Ltd.)
(C-2) Magnesium oxide, BET specific surface area of 30 m²/g, average particle size 0.6 µm (product name: Kyowamag MF 30, manufactured by Kyowa Chemical Industry Co., Ltd.)
(C-3) Magnesium oxide, BET specific surface area of 155 m²/g, average particle diameter of 7 µm (product name: Kyowamag 150 manufactured by Kyowa Chemical Industry Co., Ltd.)
(C-4) Zinc oxide, BET specific surface area of 60 to 90 m²/g (product name: active zinc oxide AZO, manufactured by Seido Chemical Industry Co., Ltd.)

### (D) Polyalkylene Glycol

(D-1) Product name: PEG6000S (manufactured by Sanyo Chemical Industries, Ltd.)

### (E) Hindered Amine Compound

(E-1) Bis(2,2,6,6-tetramethyl-4-piperidyl) sebacate (TINUVIN 770 DF: manufactured by BASF).
(E-2) Condensate of 1,2,3,4-butanetetracarboxylic acid, 1,2,2,6,6-pentamethyl-4-piperidinol and β,β,β′,β′-tetramethyl-3,9-(2,4,8,10-tetraoxaspiro [5.5]undecane)diethanol (Adeka stab LA-63P: manufactured by ADEKA Co., Ltd.)
(E-3) Tetrakis(1,2,2,6,6-pentamethyl-4-piperidyl)1,2,3,4-butanetetracarboxylate (Adeka stab LA-52: manufactured by ADEKA Co., Ltd.)
(E-4) Condensate of 1,2,3,4-butanetetracarboxylic acid, 1,2,2,6,6-pentamethyl-4-piperidinol, and tridecyl alcohol (Adeka stab LA-62: manufactured by ADEKA Co., Ltd.)

### (F) Ultraviolet Absorber

(F-1) 2-(2H-benzotriazol-2-yl)-4,6-bis(1-methyl-1-phenylethyl)phenol (TINUVIN 234: manufactured by BASF)
(F-2) N-(2-ethylphenyl)-N′-(2-ethoxy-phenyl)oxamide (Sanduvor VSU: Clariant Co., Ltd.)

### <Examples and Comparative Examples>

Each Component shown in Tables 1 and 2 was added and mixed at a proportion shown in Tables 1 and 2, and each mixture obtained was melt-kneaded by a twin-screw extruder to prepare a pellet-like polyacetal resin composition. Numerical values in the Tables are in parts by mass.

### <Evaluation>

Using the polyacetal resin compositions prepared as described above, ISO type 1-A multipurpose test pieces having a thickness of 4 mm were prepared by injection molding under the following conditions, and the following evaluation was performed. The results are shown in Tables 1 and 2.
· Molding machine: EC-40 (Toshiba Machine Co., Ltd.)
· Molding conditions: cylinder temperature (°C) nozzle-C1-C2-C3 205 215 205 185° C.

Injection pressure: 40 (MPa)
Injection velocity: 1.5 (m/min)
Mold temperature 90 (°C)

### Weathering Resistance

Weathering resistance was evaluated according to SAE J2527 using the following apparatus and conditions.
Test apparatus: Ci4000 Xenon Weather-Ometer (manufactured by ATLAS)
Light source: xenon arc lamp
Irradiation illuminance: 0.55 W/m² wavelength 340 nm
Black panel temperature: 70° C.
Humidity: 50% RH
Filter: (inner) quartz, (outer) borosilicate “S” type.
Setting the following conditions as 1 cycle, and 152 cycles (corresponding to an irradiation
intensity of 600 kJ) were tested.

1. Dark (0 J/m²), double-side water injection - 60 min
2. Light (1320 J/m²) - 40 min
3. Light (660 J/m²), front water injection - 20 min
4. Light (1980 J/m²) - 60 min

The surface of the test piece after treatment was observed visually and with a microscope, and the weathering resistance was classified based on the state of crack generation as follows.
o: No Abnormality in appearance
Δ: Cracks can be confirmed by observation under a stereomicroscope (magnifying power: 50 magnifications).
^{×}: Cracks can be visually confirmed.

### Evaluation of Resistance to Acidic Cleaner

In order to evaluate acidic cleaner resistance of each polyacetal resin composition, a multipurpose test piece was fixed at both ends thereof, and was bent at a rate of a load strain of 2.0%. Then, an acidic cleaner was sprayed on the surface of the tensile test piece, and the tensile test piece after spraying was left for 4 hours under the condition of 60° C. The tensile test piece was then left for 4 hours under conditions of 23° C. and 55% RH. The acidic cleaner was then sprayed again and the test piece was left for 16 hours under conditions of 23° C. and 55% RH.

As the acidic cleaner, the following acidic cleaners were used. Cleaners: sulfuric acid: 1.5% hydrofluoric acid: 1.5%, and phosphoric acid: 10% Setting spraying an acidic cleaner to a tensile test piece, then leaving the tensile test piece at 60° C. for 4 hours, then leaving the tensile test piece at 23° C. and 55% RH for 4 hours, then spraying the acidic cleaner again, and then leaving the tensile test piece at 23° C. for 16 hours as one cycle, each time this one cycle was completed, the state of crack generation on the surface of the dumbbell test piece was visually observed. The test pieces were classified into ×, Δ, and o according to the following number of cycles at which a crack was confirmed.
×: less than 6
Δ: 6 or more and less than 16
o: 16 or more

### Evaluation of Resistance to Acidic Cleaners After Ultraviolet Irradiation (Acid Resistance #2)

The test piece was withdrawn after the completion of 38 cycles of the weathering resistance evaluation of the above (1), and acid resistance evaluation was performed under the above condition (2). The classification of the evaluation results applies to this case.

### Nominal Tensile Strain at Break

Measurement of nominal tensile strain at break according to ISO 527-1, 2 was carried out, and the results were determined as being from ×, Δ, and o as follows. The temperature and humidity conditions of the measuring chamber were 25° C. and 50% RH.
×: less than 5%
Δ: 5% or more and less than 8%
o: 8% or more

### Bleeding

Multipurpose test pieces were stored at 60° C. and 95% RH for 96 hours.

### «Evaluation Method»

The appearance of each stored test piece was visually classified as follows.
o: No bleeding was observed on the surface of the test piece.
Δ: A small amount of bleeding was observed on the surface of the test piece.
×: A large amount of bleeding was observed on the surface of the test piece.

TABLE 2

| | | | Example | | | | | | | | | | | | | | | | |
|---|---|---|---|---|---|---|---|---|---|---|---|---|---|---|---|---|---|---|---|
| | | | 1 | 2 | 3 | 4 | 5 | 6 | 7 | 8 | 9 | 10 | 11 | 12 | 13 | 14 | 15 | 16 | 17 |
| A | Polyacetal polymer | A-1 | 100 | 100 | 100 | 100 | 100 | 100 | 100 | 100 | 100 | 100 | 100 | 100 | 100 | 100 | 100 | 100 | 100 |
| B | Antioxidant | B-1 | 0.1 | 0.3 | 2 | | 0.3 | 0.3 | 0.3 | 0.3 | 0.3 | 0.3 | 0.3 | 0.3 | 0.3 | 0.3 | 0.3 | 0.3 | 0.3 |
| | | B-2 | | | | 0.5 | | | | | | | | | | | | | |
| C | Metal oxide | C-1 | 5 | 5 | 5 | 5 | 2.5 | 20 | | | | 5 | 5 | 5 | 5 | 5 | 5 | 5 | 5 |
| | | C-2 | | | | | | | 5 | | | | | | | | | | |
| | | C-3 | | | | | | | | 5 | | | | | | | | | |
| | | C-4 | | | | | | | | | 5 | | | | | | | | |
| D | Polyalkylene glycol | D-1 | 2 | 2 | 2 | 2 | 2 | 2 | 2 | 2 | 2 | 2 | 2 | 2 | 2 | 2 | 2 | 2 | 2 |
| E | Hindered amine compound | E-1 | 0.3 | 0.3 | 0.3 | 0.3 | 0.3 | 0.3 | 0.3 | 0.3 | 0.3 | 0.2 | 1.5 | | | | 0.3 | 0.3 | 0.3 |
| | | E-2 | | | | | | | | | | | | 0.5 | | | | | |
| | | E-3 | | | | | | | | | | | | | 0.3 | | | | |
| | | E-4 | | | | | | | | | | | | | | 0.3 | | | |
| F | Ultraviolet absorber | F-1 | 0.5 | 0.5 | 0.5 | 0.5 | 0.5 | 0.5 | 0.5 | 0.5 | 0.5 | 0.5 | 0.5 | 0.5 | 0.5 | 0.5 | 0.3 | 1.5 | |
| | | F-2 | | | | | | | | | | | | | | | | | 0.5 |
| Acid resistance | | | o | o | o | o | Δ | o | Δ | o | Δ | o | o | o | o | o | o | o | o |
| Acid resistance #2 | | | o | o | o | o | Δ | o | Δ | o | Δ | o | o | o | o | o | o | o | o |
| Weathering resistance | | | o | o | Δ | o | o | o | o | o | o | o | o | Δ | Δ | Δ | Δ | o | o |
| Nominal tensile strain at break | | | o | o | o | o | o | o | o | o | o | o | o | o | o | o | o | o | o |
| Bleeding | | | o | o | o | o | o | o | o | o | o | o | Δ | o | o | o | o | Δ | o |

TABLE 2

| | | | Comparative Example | | | | | | | | | | |
|---|---|---|---|---|---|---|---|---|---|---|---|---|---|
| | | | 1 | 2 | 3 | 4 | 5 | 6 | 7 | 8 | 9 | 10 | 11 |
| A | Polyacetal polymer | A-1 | 100 | 100 | 100 | 100 | 100 | 100 | 100 | 100 | 100 | 100 | 100 |
| B | Antioxidant | B-1 | 0.3 | 0.3 | 0.3 | 0.3 | 0.3 | 0.3 | 0.3 | 0.3 | 0.3 | 0.3 | 0.3 |
| C | Metal oxide | C-1 | | 5 | 5 | | 1 | 25 | 5 | 5 | 5 | 5 | 5 |
| | | C-2 | | | | | | | | | | | |
| | | C-3 | | | | | | | | | | | |
| | | C-4 | | | | | | | | | | | |
| D | Polyalkylene glycol | D-1 | | | 2 | 2 | 2 | 2 | 2 | 2 | 2 | 2 | |
| E | Hindered amine compound | E-1 | | | | 0.3 | 0.3 | 0.3 | 0.1 | 2.5 | 0.3 | 0.3 | 0.3 |
| | | E-2 | | | | | | | | | | | |
| | | E-3 | | | | | | | | | | | |
| | | E-4 | | | | | | | | | | | |
| F | Ultraviolet absorber | F-1 | | | | 0.5 | 0.5 | 0.5 | 0.5 | 0.5 | 0.1 | 2.5 | 0.5 |
| | | F-2 | | | | | | | | | | | |
| Acid resistance | | | × | Δ | o | × | × | o | o | o | o | o | × |
| Acid resistance #2 | | | × | × | × | × | × | o | × | o | × | o | × |
| Weathering resistance | | | × | × | × | o | o | o | × | o | × | o | Δ |
| Nominal tensile strain at break | | | o | o | o | o | o | × | o | o | o | o | o |
| Bleeding | | | o | o | o | o | o | o | o | × | o | × | o |

In the test pieces formed of the polyacetal resin compositions of Examples 1 to 17, cracks did not occur when the number of cycles was less than 16.

Contrary to this, in the test pieces formed of the polyacetal resin compositions of Comparative Examples 1, 4, 5, and 11, cracks occurred before 16 cycles were completed. Further, with regard to the acid resistance after ultraviolet irradiation, Comparative Examples 1 to 5, 7, 9, and 11 were insufficient in terms of the required performance.

In Comparative Example 6, the acid resistance and weathering resistance were improved, but the characteristics of the polyacetal resin were deteriorated. Furthermore, the nominal tensile strain at break was poor. From the Examples and the Comparative Examples, it was confirmed that the inventive products were excellent in both acidic cleaner resistance and photo resistance.

1. A polyacetal resin composition, comprising at least:
(A) a polyacetal polymer having a specific terminal property in an amount of 100 parts by mass,
(B) a hindered phenol-based antioxidant in an amount of 0.1 parts by mass or more and 2.0 parts by mass or less,
(C) at least one selected from the group consisting of oxides of magnesium and zinc in an amount of more than 2.0 parts by mass and 20 parts by mass or less,
(D) a polyalkylene glycol in an amount of 0.5 parts by mass or more and 3.0 parts by mass or less,
(E) a hindered amine compound in an amount of 0.2 parts by mass or more and 1.5 parts by mass or less, and
(F) an ultraviolet absorber in an amount of 0.2 parts by mass or more and 1.5 parts by mass or less,
wherein the polyacetal polymer has an amount of hemiformal terminal group of 1.0 mmol/kg or less.

2. The polyacetal resin composition according to claim 1, wherein the oxide of magnesium is magnesium oxide.

3. The polyacetal resin composition according to claim 2, wherein the magnesium oxide has a BET specific surface area of 100 m²/g or more.

4. The polyacetal resin composition according to claim 1, wherein (F) the ultraviolet absorber is at least one selected from the group consisiting of benzotriazole-based compounds and oxamide-based compounds.

5. The polyacetal resin composition according to claim 1, wherein (F) the ultraviolet absorber is at least one selected from the group consisiting of 2-(2H-benzotriazol-2-yl)-4,6-bis (1-methyl-1-phenylethyl)phenol and N-(2-ethylphenyl)-N′-(2-ethoxyphenyl)oxamide.

6. An automobile component comprising a molded product of the polyacetal resin composition according to claim 1.

7. The automobile component according to claim 6, wherein the automobile component is an automobile component brought into contact with an acidic cleaner.

8. A method for improving acid resistance against an acidic component, the method comprising using the acetal resin composition according to claim 1.

9. The method according to claim 8, wherein the acidic component is derived from an acidic cleaner.
